(19) United States
(12) Patent Application Publication
(10) Pub. No.: US 2004/0150175 A1
(43) Pub. Date: Aug. 5, 2004

(54) Travois apparatus and method

(76) Inventor: George F. Cepull, Orem, UT (US)

Correspondence Address: Kulaniakea Fisher, Hill, Johnson & Schmutz, 3319 North University Avenue, Provo, UT, 84604, US

(21) Appl. No.: 10/357,177

(22) Filed: Feb. 3, 2003

(51) Int. Cl. B62B 1/00

(52) U.S. Cl. 280/47.24

(57) ABSTRACT

A travois is provided for pulling behind an operator including a frame having distal and proximal ends, at least two spaced-apart wheels rotatably coupled to the distal end of the frame, and a harness. The proximal end of the frame is coupled to the harness, and the harness is adapted to be pivotally coupled to the operator. A method of transporting a load on a travois behind an operator is provided that includes positioning the load on a frame between first and second ends of the frame, supporting the load at the first end by two spaced-apart wheels, and attaching the second end to the operator so that the hips of the operator support the load at the second end.

### FIELD

This disclosure generally relates to a personal travois and more particularly to a personal travois for use in backcountry and urban surroundings.

### BACKGROUND

When an individual has the desire or need to access remote areas of wilderness or “off the beaten track” geographical locations, it is important to have the basic necessities of survival and daily living requirements available. Moreover, it is desirable to take other non-essential items to make the experience more enjoyable. Currently, access to remote areas of the backcountry is often limited to methods that do not allow for the use of motorized vehicles. This restriction requires those venturing into the backcountry to transport their supplies by their own power. Many such hikers utilize backpacks to carry their supplies and gear. As a result, those who are not able to endure the physical strain of carrying 30 or more pounds on their backs over uneven or challenging terrain are precluded from enjoying the backcountry or other areas in the wilderness.

Thus, there is a need for a wheeled apparatus that can provide mobility, and reduce the difficulty of carrying materials into the wilderness or backcountry. To this end, several designs have attempted to build a cart or travois to allow those unable to carry a backpack to be able to venture into the backcountry. One such design is disclosed in U.S. Pat. No. 4,055,354 issued to Sharpe (Sharpe). Sharpe describes a single wheeled cart with load carrier baskets astride a single wheel that is centrally located on an elongate frame and includes two handlebars. While taking some of the weight of the load off of the carriers and transferring it to the travois, the Sharpe design is unstable because it is subject to tipping. Such designs are not well suited for the uneven, challenging, and varied terrain found in the wilderness or backcountry.

Other designs have attempted to address the stability issue by providing counterweights. One such design is disclosed in U.S. Pat. No. 6,139,333 issued to Western (Western). While providing more stability than the Sharpe design, the Western device places the load lower to the ground. Such placement increases the likelihood of snags on obstacles commonly found on the trail.

Some recent designs utilize multiple wheels to overcome the instability issues inherent with single wheeled construction. U.S. Pat. No. 6,039,333 issued to Hamblin (Hamblin) discloses a hiker's utility trail cart that includes a load support frame having a handlebar and two wheels rotatably secured to the distal portion of the frame. The wheels can be interchangeably mounted in a narrow stance or a wide stance. Hamblin also discloses the use of a harness that is removably secured to a cross piece of the frame member through the use of buckles. The harness includes the use of a belt, similar to a belt worn when lifting a heavy weight. While improving stability over one-wheeled designs, the Hamblin design concentrates most of the load on the abdominal region of the body or else requires the operator to carry part of the load with the arms. This design limits the usefulness of the cart in the backcountry.

Further limitations arise due to the large turning radius of designs with non-pivoting, rigid waist harnesses, such as in the apparatus disclosed by U.S. Pat. No. 5,820,141 issued to Wilkerson et. al. (Wilkerson). This patent discloses a one-man carrier and backpack having a cylindrical, inflatable roller. Wilkerson describes the frame being attached to the operator via a waist belt, thereby being subject to the problems of the Hamblin design, in addition to trail mobility limitations because of the large cylindrical roller.

Accordingly, there exists the need for a travois that is lightweight, that is operable in a variety of conditions, that has a shorter turning radius, that has adequate ground and snag clearance, and that can haul a variety of supplies while reducing the load transferred to the operator.

### SUMMARY

In one implementation, a travois for pulling behind an operator is provided that includes a frame comprising distal and proximal ends, at least two spaced apart wheels rotatably coupled to the distal end of the frame, a harness, the proximal end of the frame being coupled to the harness; and the harness being adapted to be pivotally coupled to the operator.

Another implementation comprises a travois and harness assembly for an operator to transport a load, having a frame comprising at least two elongated members supporting the load, at least two spaced apart wheels rotatably coupled to the frame for supporting a portion of the load on a surface, a harness adapted to be worn by the operator, an attachment device on the frame for attaching the frame to the harness, and a receptacle device on the harness for connecting to the attachment device to transfer a substantial portion of the load to the hips of the operator.

In another implementation, a travois and harness assembly are provided for an operator to transport a load. A frame comprises at least two elongated members supporting the load. At least two spaced apart wheels are rotatably coupled to the frame for supporting a portion of the load on a surface. A harness is adapted to be worn by the operator. An attachment device is positioned on the frame for attaching the frame to the harness. The harness is adapted to enable the operator to substantially pivot or twist in the harness while the frame is stationary to enable the operator to maneuver the assembly.

Yet another implementation comprises a travois for pulling a load behind an operator. Two spaced-apart elongated members having first and second ends have an axle connected between them near the first end. Two wheels are connected to the axle so that the wheels are spaced further apart than the elongated members. A cross bar is connected between the elongated members. An attachment is disposed near the second end of the elongated members for attaching the members to the operator.

Still another implementation comprises a travois for pulling behind an operator, comprising a frame having at least two spaced apart members. The members have distal and proximal ends, the proximal end of the spaced apart member further comprising a generally downwardly angled section. At least one ski is coupled to each of the distal ends of the spaced apart members.

Yet another implementation comprises a method of transporting a load on a travois behind an operator. The method includes positioning the load on a frame between first and second ends of the frame, supporting the load at the first end by two spaced-apart wheels, and attaching the second end to the operator so that the hips of the operator support the load at the second end.

### BRIEF DESCRIPTION OF THE DRAWINGS

FIG. 1 is a perspective view of one implementation of the travois according to the present disclosure, with the travois being loaded and pulled by hiker;

FIG. 2 is another perspective view of the travois shown in FIG. 1;

FIGS. 3A-C are views with the operator pivoted relative to the travois and harness and depicting the small turning radius of the travois;

FIGS. 4A and 4B are partial perspective views of the end of the travois of FIG. 1 in relation to a pocket on the harness;

FIGS. 5A and 5B are perspective views of the travois of FIG. 1;

FIG. 6 is a bottom plan view of the travois of FIG. 1;

FIG. 7 is a partial close-up view showing the hand brake and related wheel brake in greater detail;

FIG. 8 is an end perspective view of the travois of FIG. 1;

FIG. 9 is a partial perspective view of the rear portion of the travois of FIG. 1;

FIG. 10A is a side view of the travois and harness of FIG. 1;

FIG. 10B is a close-up view of a portion of the implementation shown in FIG. 10A;

FIG. 11 is a perspective view of the travois of FIG. 1 depicting the hiker in a resting position;

FIG. 12 is a perspective view of the travois of FIG. 1 depicting the hiker utilizing the frame as a wheelbarrow;

FIG. 13 is a perspective view of an alternative implementation of the embodiment of FIG. 1 depicting a seat disposed on the frame for carrying disabled persons and other loads; and

FIG. 14 is an alternative implementation a travois coupled to skis for travel over snow and ice.

### DETAILED DESCRIPTION

In one implementation, the travois may be a two wheeled collapsible carrier for manually transporting items such as camping supplies, water, tents, sleeping bags, firewood, groceries, game, climbing equipment, and/or photographic equipment over a wide range of outdoor trails and mountain terrain without having to carry such items on the back.

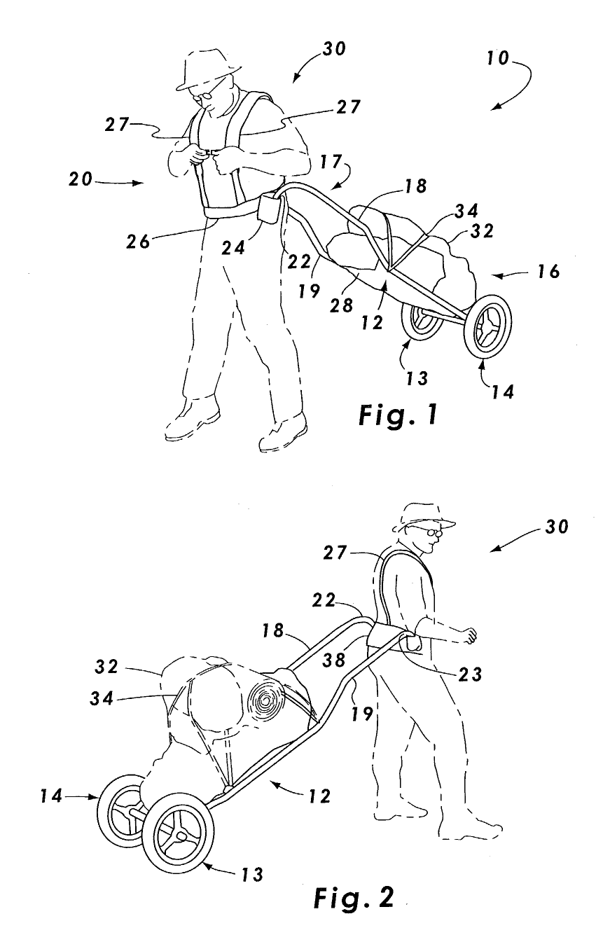

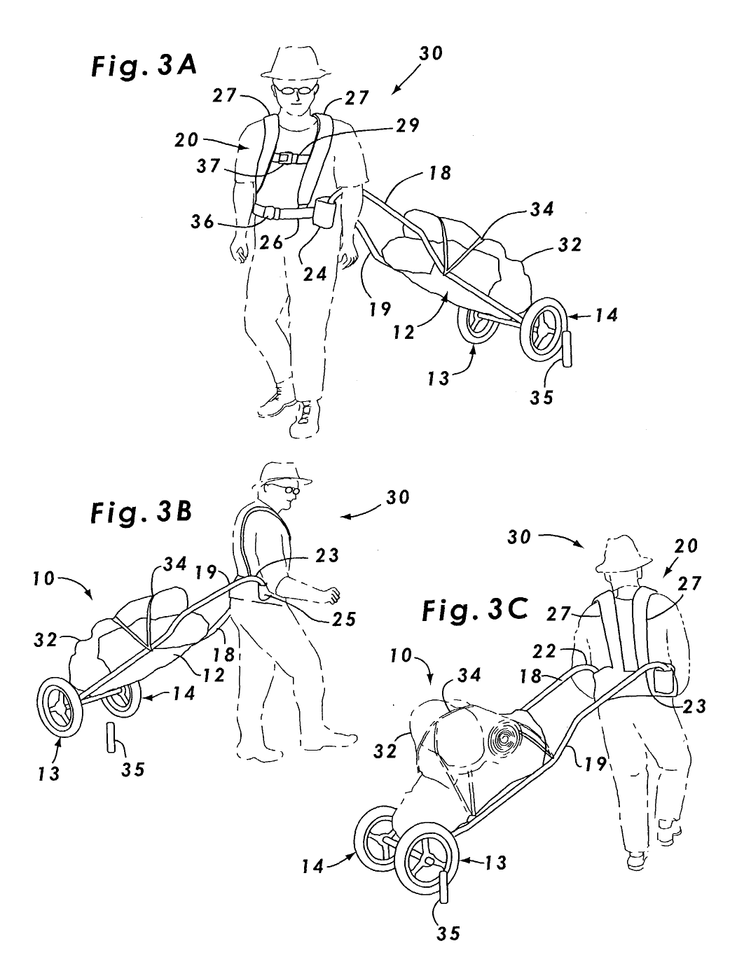

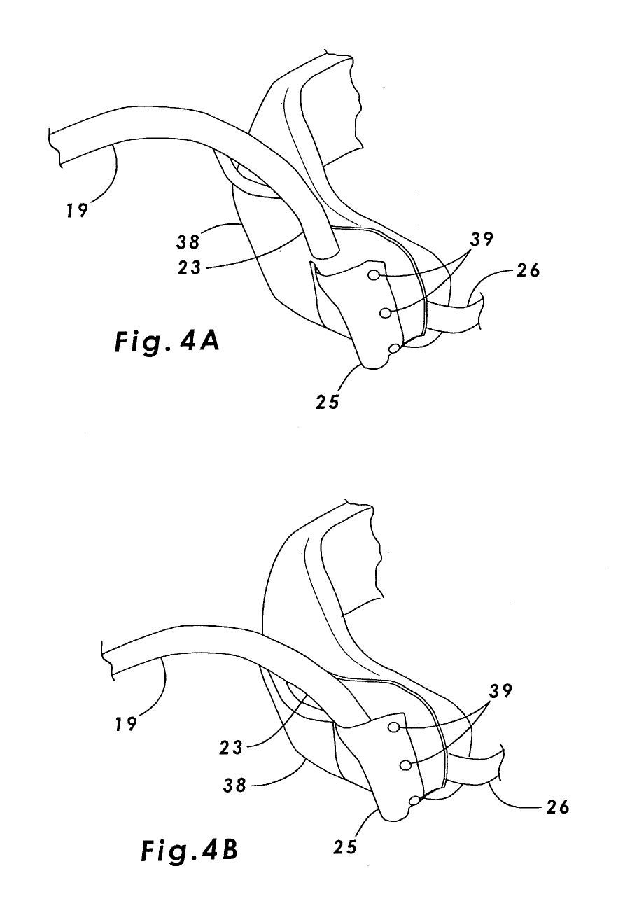

Referring to FIGS. 1 and 2, an improved travois 10 generally includes a frame 12, two wheels 13 and 14 coupled to a distal end 16 of the frame 12, and a harness 20 coupled to the proximal end 17 of the frame 12. Frame 12 includes two parallel elongate members 18, 19 that extend to the proximal end 17 of frame 12, terminating as downward bent ends 22 and 23 (best seen in FIGS. 3B-C). Harness 20 includes two shoulder straps 27 and a waist belt 26 with two pockets 24 and 25 (best seen in FIGS. 3B-C) on either side of waist belt 26. A reinforcement member 38 connects to belt 26 at the back of the harness 20, as will be discussed later.

In operation, a hiker 30 attaches the harness 20 to his waist and shoulders to pull the travois 10. The ends 22 and 23 of frame 12 are inserted into the pockets 24 and 25 on belt 26. The travois 10 includes a support pallet 28 connected between elongate members 18 and 19 to support a load 32 of various items to be transported. Straps 34 are connected to the frame 12 so as to secure the load 32 on the pallet 28.

The above described construction provides a travois and harness assembly wherein a substantial amount of the load on the travois is carried on the wheels of the travois. The remaining portion of the load is transferred to the hips and legs of the hiker, which are able to support substantial loads more easily than the arms or the shoulders of the hiker. The travois angles upward from the wheels to the hips of the hiker so that much of the load is carried by the wheels. The angle formed between the travois frame and the ground may be 40 degrees or greater Such a configuration may provide a mechanical advantage of 3:1 or 4:1 or possibly greater, depending on the load configuration.

Now referring to FIGS. 3A-C, the harness 20 is shown in closer detail, including the waist belt 26, shoulder straps 27, and pockets 24 and 25. In the illustrated implementation, the waist harness 26 is a padded waist harness and may include durable reinforcements on the outside and on the inside (not shown). The reinforcements may be made of leather, although any suitably durable material could be utilized.

Also shown in FIGS. 3A-C are the turning features of the travois 10. The operator 30 pivots to the left while turning the travois 10 about a stake 35 to illustrate the small turning radius of the travois 10. In other words, the travois operator is able to change directions while the wheels 13 and 14 of the travois 10 substantially rotate on a vertical axis (illustrated by the stake 35). The configuration of the harness 20 allows the harness to secure the load 32 applied by the travois 10 and distribute the load to the operator 30 while allowing the operator to pivot with respect to the harness 20. Accordingly, by allowing the operator 30 to twist with respect to the harness 20, the travois 10 can be turned in a much smaller radius than would otherwise be possible. The harness 20 should be constructed to allow the operator to pivot or twist up to 90 degrees relative to the travois frame.

In FIG. 3A, the travois 10 is headed in a first direction with the operator, rotated with respect to the harness by 90 degrees, about to begin a turn. In FIG. 3B the travois 10 is shown half turned, with the operator 30 rotated with respect to the harness 20 by 90 degrees, as in FIG. 3A. FIG. 3C shows the travois headed in a direction opposite of that shown in FIG. 3A, whereby the operator 30 is now aligned with the travois 10 and the stake 35 is in front of the right wheel 13. The operator 30 is ready to move forward with the travois 10 moving in a direction opposite of FIG. 3A. Such a configuration allows the travois 10 to have a turning radius equal to the length of the travois 10. Such a turning radius is much less than that of previous designs. As seen in FIGS. 3A-C, such a reduction in turning radius increases the versatility of the travois 10 by making it usable on trails that were previously only accessible by backpack and by allowing the operator 30 to easily maneuver between and around rocks, trees, and other obstacles.

The waist belt 26 may be secured by a one-push release snap buckle 36 or other suitable type of buckle or securing means of conventional design. The shoulder straps 27 are attached to the waist belt 26 at the front and back of the belt. The shoulder straps 27 may be padded and connected in the front portion by a selectively attachable cross-chest strap 29 also having a conventional buckle 37. Accordingly, the travois 10 may be easily removed by releasing the snap buckles 36 and 37 and removing the harness 20.

As best seen in FIGS. 3A-C, 4A and 4B, the two pockets 24 and 25 are secured to the waist belt 26 and may be made of a durable material. The belt 26 and pockets 24 and 25 are attached to a reinforcement member 38 so as to support the weight transferred from the frame 12 to the operator 30. In the illustrated implementation, the pockets 24 and 25 may be made of leather and connected to the durable reinforcement member 38 by multiple rivets 39.

The proximal ends of the two elongate members 18 and 19 include bent or angled ends 22 and 23. The angled ends 22 and 23 allow the proximal ends of the elongate members 18 and 19 to be “dropped in” to pockets 24 and 25 attached to the waist belt 26. Once thus engaged, the pockets 24 and 25 provide a connection for the operator 30 to pull the travois 10 and a means for maintaining the travois 10 stable and less likely to capsize.

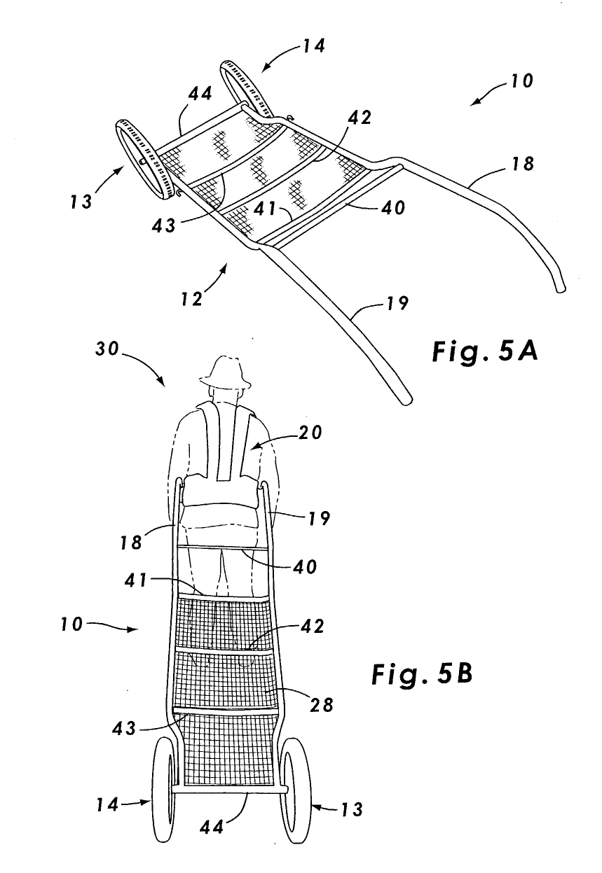

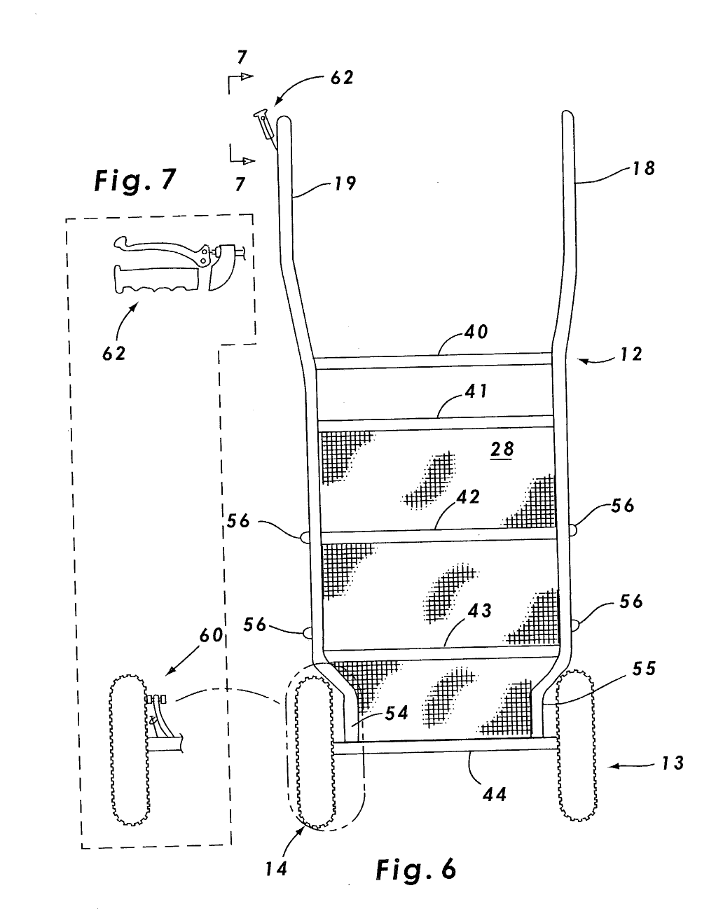

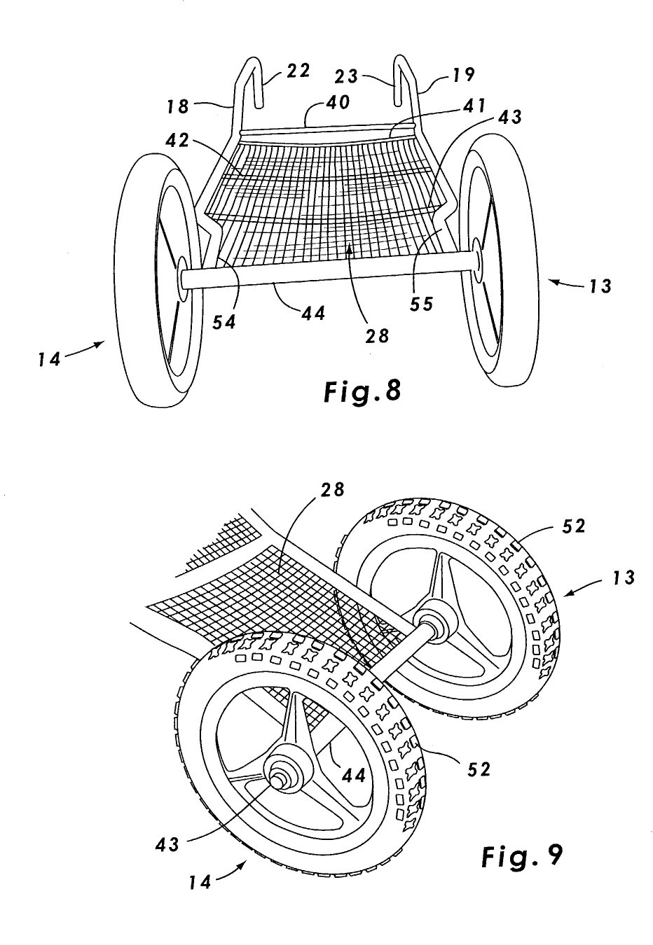

Referring now to FIGS. 5 through 8, the construction of the disclosed embodiment of the travois is shown in more detail. FIG. 5A illustrates a perspective view. FIG. 5B shows a rear view of the travois 10 and illustrates how the travois 10 is sufficiently narrow to effectively follow the operator 30 over even quite narrow trails. FIG. 6 shows a bottom plan view, and FIG. 8 illustrates a rear perspective view of the travois 10. The elongate members 18 and 19 of the frame 12 may be spaced apart and connected by cross members 40 and 44. The cross members 40 and 44 provide a stable base for attaching cargo. Three straps 41, 42 and 43 extend between members 18 and 19 for supporting the load 32 and pallet 28 as will be discussed hereafter. The pallet 28 is attached to members 18 and 19 and supported by straps 41, 42 and 43 for holding load 32 (as seen in FIGS. 1, 5A and 6). Members 18 and 19 are bent inward at angled sections 54 and 55 to provide for clearance between the frame 12 and the wheels 13 and 14.

As shown in FIG. 7, a brake 60 may also facilitate the use of the travois 10 on varying terrain. In one implementation, a brake actuation assembly 62 is a hand held assembly that is coupled to the brake unit 60 disposed on the distal end of the frame 12 and is operably connected to at least one of the wheels 13 and 14. In the illustrated implementation, the hand brake assembly 62 and the brake unit 60 are connected by bicycle brake cable and housing.

Looking at FIG. 9, the wheels 13 and 14 are coupled to the last of the cross members 44 that acts as an axle. The wheels 13 and 14 may include pneumatic tires 52 with knobby tread to allow for greater traction on loose or uneven surfaces. Each wheel 13 and 14 may be made of high strength molded plastic that is fixed to the axle 44 with one Allen bolt 43 for simplicity. Such a configuration allows the wheels 13 and 14 to be easily removed. The wheels 13 and 14 may also be of a hard rubber type for use in different terrain applications. The wheels have a large enough diameter, such as 14 inches, to allow the axle to clear the usual obstacles found along a mountain trail.

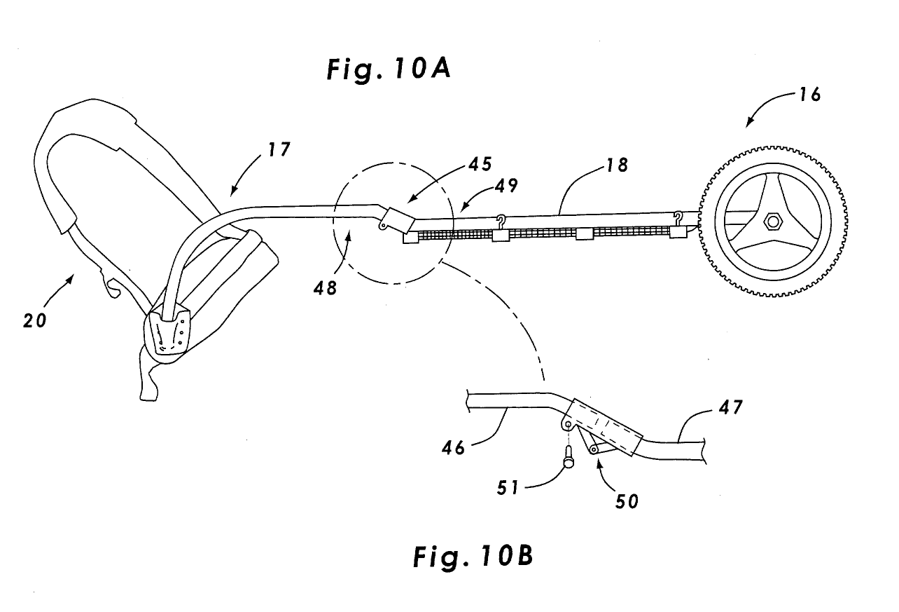

Referring now to FIGS. 10A and 10B, a hinge assembly 45 may be included between the distal and proximal ends 16 and 17 of elongate members 18 and 19. The hinge assembly 45 couples intermediate proximal and intermediate distal portions 48 and 49 of the frame 12 and allows the frame 12 to be folded. The hinge assembly 45 includes two hinge arms 46 and 47, coupled to each other by a pivot assembly 50. The hinge arms 46 and 47 are further pivotably connected to the intermediate proximal and intermediate distal portions respectively. A pin 51 secures the frame in a locked position. Removal of the pin 51 allows the elongate members 18 and 19 to fold without becoming detached.

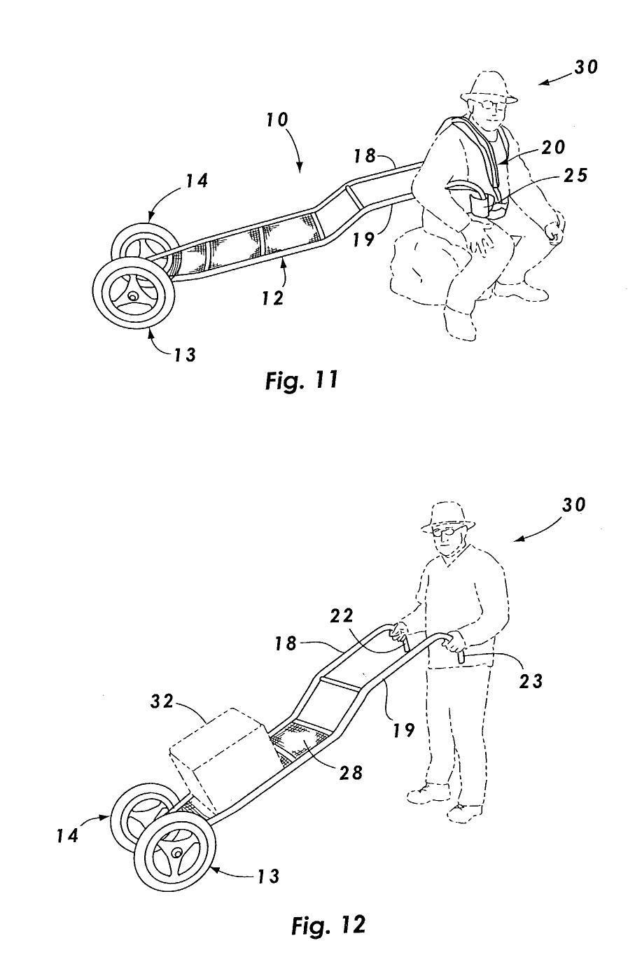

As seen in FIG. 11 the configuration of the travois 10 allows the operator 30 to sit while resting without disengaging the harness 20. As seen in FIG. 12, the angled ends 22 and 23 may be removed from the pockets 24 and 25 to provide convenient handles. Accordingly, the operator 30 may wish to disengage the angled ends 22 and 23 from the harness 20 in order to use the travois 10 in a wheelbarrow type configuration to carry a load 32.

Referring to all of the forgoing figures, with regard to further detail about the travois 10, in one implementation, the elongate members 18 and 19 and cross members 40 and 41 are constructed of 3/4 inch lightweight rigid steel conduit, with an overall length of about 67 inches. The elongate members may include several angled or bent sections. As previously discussed, the angled ends 22 and 23, located on the proximal ends of the elongate members 18 and 19, facilitate coupling of the frame 12 to the harness 20. Second and third angled sections 46 and 47, located on the intermediate distal portion of the elongate members 18 and 19 facilitate folding of the frame 12 by use of hinge assembly 44. Fourth and fifth angled sections 54 and 55 provide for clearance between the frame 12 and the wheels 13 and 14. The wheels 13 and 14 are be coupled to the distal end 16 of the frame 12 by the axle 44, which may be the last of the cross members connecting the elongate members 18 and 19.

The pallet 28 may be a lightweight durable mesh extended from the distal end 16 of the frame 12 to the intermediate distal portion 49 of the frame 12 and between the elongate members 18 and 19 to further facilitate the attachment of cargo, although the use of mesh is not required in order to secure cargo to the frame 12. The mesh 28 is ½″×½″ steel wire mesh attached to the frame by self-tapping screws. In addition to a durable mesh, tie down loops 56 may also be disposed on the outside of each of the elongate members 18 and 19 to facilitate the use of tie downs.

Straps 41-43 may be one inch wide and 16¼ thick steel strapping cut to 16¼ inches in length. The first strap 43 is welded to the elongate members 11½ inches above axle 44, with two more straps 41 ands 42 welded at 10-inch intervals from each other. In addition, for structural support, a 3/8 inch diameter rod 40 may be disposed between the elongate arms 18 and 19 at the intermediate distal portion 21, and the elongated arms 18 and 19 may also be welded to the axle 44 or last cross member on the distal end 16 of the frame 12. Furthermore, the frame 12 may be coated with a baked-on powder coat paint finish applied to all exposed metal components to prevent rust and deterioration that may occur due to exposure to the elements. While this implementation makes extensive use of steel, those of skill in the art will appreciate that the frame may be made of any suitable material, including titanium, aluminum, high strength composites, or any other suitable material.

In other implementations (not shown) a detachable cover may be attached to the rod between the intermediate proximal portions of the elongate members to provide the load protection from the elements. Furthermore, an aluminum tube (or other elongate member of a suitable material) may be secured to the rod to accept a rotating platform suitable for securing a camber in order to provide a fixed platform in lieu of a tripod.

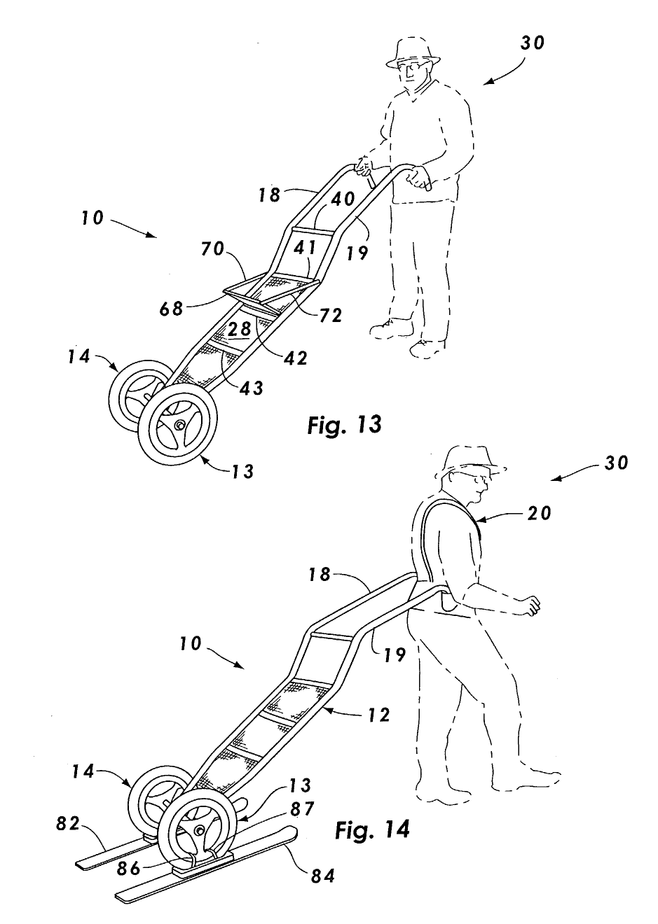

Even further, a small platform may be affixed on rear facing axle housing for addition balance for the support of unwieldy or non-conforming loads such as game animals, etc. As seen in FIG. 13, the small platform is a seat 68 and is attached to the travois 10 for transporting disabled persons moderate distances over paved or unpaved surfaces or may also act as a secured seat with lap harness when destination is reached. The seat 68 is pivotally secured to cross member 42 and is further secured to the frame 12 by the use of two straps 70 and 72 that extend around the elongate members 18 and 19.

The straps 70 and 72 may also extend around cross members 40 or 41 to be secured by buckles (not shown). Additionally, an adjustable waist strap (not shown) may extend from elongate member 18 to elongate member 19 and may include a buckle (not shown) for securing the strap to a passenger (not shown). When not in use, the seat 68 may fold flat against the pallet 28. In the illustrated implementation, the seat is approximately 9 inches by 12 inches and is made of a lightweight, rigid material. In other implementations (not shown), the seat may be made of a durable fabric material and/or the seat may be supported on the pallet 28 by braces or any other suitable supports.

In FIG. 13, the travois is show being used in wheelbarrow fashion. It is understood that the travois with seat extended may also be supported in the hiking position shown in FIGS. 1-3, in order to carry a person or other load in that manner.

Referring to FIG. 14, one implementation may include specially adapted skis 82 and 84 attached to the wheels 13 and 14 to allow for travel over snow. Such attachment may be done by straps 86 and 87, by a binding system or by any other suitable manner or attachment.

As can be seen from the foregoing description, a travois is provided that enables an operator to transport a substantial load over rough terrain and trails with substantial ease and safety. The travois and harness construction enables much of the load to be supported by wheels on the travois frame and the remainder of the load to be supported by the hips of the operator. The harness arrangement enables the operator to pivot or swivel relative to the frame, thereby allowing the travois to be turned sharply. The wheels are spaced far enough apart to provide for stability but are still close enough together to enable good mobility on narrow trails. The pneumatic tires enable the travois to be transported over a variety of rocks, branches and other obstacles. The axle between the wheels is high enough to clear the usual obstacles encountered along a trail.

While this disclosure has been described as having a preferred design, the present disclosure can be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims.

I claim:

1. A travois for pulling behind an operator, comprising:
a frame comprising distal and proximal ends;
at least two spaced apart wheels rotatably coupled to the distal end of the frame;
a harness;
the proximal end of the frame being coupled to the harness; and
the harness being adapted to be pivotally coupled to the operator.

2. The travois of claim 1, further comprising a hinge assembly disposed between the distal and proximal end of the frame, the hinge assembly facilitating folding of the travois.

3. The travois of claim 1 wherein the harness comprises a waist belt and shoulder straps.

4. The travois of claim 3 wherein the harness further comprises two spaced apart attachment devices on the waist belt, the attachment devices being adapted to removably engage the proximal end of the frame.

5. The travois of claim 4 wherein the proximal end of the frame comprises two members adapted to removably engage the attachment devices on the waist belt of the harness.

6. The travois of claim 5 wherein the two members are bent members and the attachment devices are receptacles adapted to receive the bent members.

7. The travois of claim 1 further comprising at least one hand brake assembly for controlling the speed of the travois.

8. The travois of claim 1 wherein the frame comprises at least two elongate members extending between the distal and proximal ends of the frame.

9. The travois of claim 8 further comprises a plurality of cross bars connecting the elongate members.

10. The travois of claim 8 further comprising a pallet extending between the elongate members for supporting a load on the travois.

11. A travois and harness assembly for an operator to transport a load, comprising:
(a) a frame comprising at least two elongated members supporting the load;
(b) at least two spaced apart wheels rotatably coupled to the frame for supporting a portion of the load on a surface;
(c) a harness adapted to be worn by the operator;
(d) an attachment device on frame for attaching the frame to the harness; and
(e) a receptacle device on the harness for connecting to the attachment device to transfer a substantial portion of the load to the hips of the operator.

12. The assembly of claim 11, wherein the attachment device comprises an end portion of each of the elongated members, formed to attach to the receptacle device.

13. The assembly of claim 12, wherein the harness comprises a belt adapted to be secured to the waist of the operator, and the receptacle device comprises receptacles on opposing sides of the belt to receive the end portions.

14. The assembly of claim 11, wherein the spaced apart wheels are coupled to a first end of the frame and the attachment device is on another end of the frame, so that the travois forms an angle with the surface from the wheels to the hips of the operator.

15. The assembly of claim 14, wherein the angle formed by the travois is such that a substantial portion of the load is carried by the wheels and the remainder of the load is carried by the hips of the operator.

16. The assembly of claim 14, wherein the angle is at least 40 degrees.

17. A travois and harness assembly for an operator to transport a load, comprising:
(a) a frame comprising at least two elongated members supporting the load;
(b) at least two spaced apart wheels rotatably coupled to the frame for supporting a portion of the load on a surface;
(c) a harness adapted to be worn by the operator; and
(d) an attachment device on the frame for attaching the frame to the harness, wherein the harness is adapted to enable the operator to substantially pivot or twist in the harness while the frame is stationary to enable the operator to maneuver the assembly.

18. The assembly of claim 17, wherein the harness includes a receptacle device on the harness for connecting to the attachment device to transfer a substantial portion of the load to the hips of the operator.

19. The assembly of claim 17, wherein the harness is adapted so that the attachment device can remain substantially stationary relative to the frame while the operator pivots or twists in the harness.

20. The assembly of claim 17, wherein the operator can pivot or twist at least 45 degrees relative to the frame.

21. A travois for pulling a load behind an operator, comprising:
(a) two spaced-apart elongated members having first and second ends;
(b) an axle connected between the elongated members near the first end:
(c) two wheels connected to the axle so that the wheels are spaced further apart that the elongated members;
(d) a cross bar connected between the elongated members; and
(e) an attachment near the second end of the elongated members for attaching the members to the operator.

22. The travois of claim 21, wherein the elongated members are angled outward from the axle to increase the area for supporting the load.

23. The travois of claim 21, further comprising a pallet extending between the elongate members for supporting the load.

24. The travois of claim 23, further comprising straps extending between the elongated members for supporting the pallet.

25. The travois of claim 21, wherein the attachment comprises a device adapted to transfer a substantial amount of the load to the hips of the operator.

26. The travois of claim 21, wherein the elongated members each have a discontinuity between the first and second ends.

27. The travois of claim 26, wherein the discontinuity is a hinge assembly enabling the elongated members to be folded for transporting.

28. The travois of claim 26, wherein the discontinuity is a connection mechanism enabling the elongated members to be disconnected at the discontinuity for transporting.

29. The travois of claim 21 further comprising a seat adaptable to be secured to the frame for carrying a person.

30. A travois for pulling behind an operator, comprising:
a frame,
the frame comprising at least two spaced apart members,
the members comprising distal and proximal ends;
the proximal end of the spaced apart member further comprising a generally downwardly angled section; and
at least one ski coupled to each of the distal ends of the spaced apart members.

31. The travois of claim 30, further comprising a plurality of cross members between the spaced apart members.

32. The travois of claim 31, further comprising a harness having an attachment device on the harness, wherein the proximal end of the frame is removably coupled to the attachment device on the harness; and the harness is adapted to be pivotally coupled to the operator.

33. A method of transporting a load on a travois behind an operator, comprising:
(a) positioning the load on a frame between first and second ends of the frame;
(b) supporting the load at the first end by two spaced-apart wheels; and
(c) attaching the second end to the operator so that the hips of the operator support the load at the second end.

34. The method of claim 33, wherein the second end is attached to the operator by connecting the second end to a harness on the operator.

35. The method of claim 33, wherein the frame makes an angle with the horizontal from the wheels to the hips of the operator.

36. The method of claim 35, wherein the angle is at least 40 degrees.

37. The method of claim 33, wherein the second end is attached to the operator so that the operator can substantially pivot or swivel relative to the frame to facilitate maneuvering the travois.
